(19) United States
(12) Patent Application Publication
(10) Pub. No.: US 2026/0135221 A1
(43) Pub. Date: May 14, 2026

(54) BATTERY PACK

(71) Applicant: SK On Co., Ltd., Seoul (KR)

(72) Inventors: Jong Hwa LEE, Daejeon (KR); Sung Wan PARK, Daejeon (KR)

(21) Appl. No.: 19/360,998

(22) Filed: Oct. 17, 2025

(30) Foreign Application Priority Data
Oct. 17, 2024 (KR) 10-2024-0142336

(51) Int. Cl. H01M 50/242; H01M 50/204; H01M 50/262; H01M 50/291

(52) U.S. Cl. CPC H01M 50/242; H01M 50/204; H01M 50/262; H01M 50/291

(57) ABSTRACT

A battery pack includes a cell assembly including at least one battery cell, a pack housing accommodating the cell assembly and including a pack frame facing the cell assembly, a gap filling plate mounted on the pack frame and disposed between the pack frame and the cell assembly, a fastening member coupling the gap filling plate to the pack frame, and a ratchet plate disposed between the gap filling plate and the pack frame.

### CROSS-REFERENCE TO RELATED APPLICATION(S)

This patent document claims the priority and benefits of Korean Patent Application No. 10-2024-0142336 filed on Oct. 17, 2024, the disclosure of which is incorporated herein by reference in its entirety.

### TECHNICAL FIELD

The disclosure and implementations disclosed in this patent document generally relate to a battery pack.

### BACKGROUND

Unlike primary batteries, secondary batteries may be charged with and discharged of electricity, and thus, may be applied to devices within various fields, such as digital cameras, mobile phones, laptops, hybrid vehicles, electric vehicles, and energy storage systems (ESS). Secondary batteries may be lithium-ion batteries, nickel-cadmium batteries, nickel-metal hydride batteries, or nickel-hydrogen batteries.

Secondary batteries are manufactured as flexible pouch-type battery cells or rigid prismatic or cylindrical can-type battery cells. A plurality of battery cells may be arranged inside a module housing to form a battery module.

### SUMMARY

A battery pack may include a plurality of battery cells. Battery cells may swell due to overcharging, overdischarging, aging, etc. As the battery cells swell, the pressure (e.g., surface pressure) transferred to the battery cells may change.

The present disclosure may be implemented in some embodiments to provide a battery pack in which a specified amount of pressure is provided to a battery cell, thereby improving the lifespan of the battery cell.

The battery module and battery pack of the present disclosure may be widely applied to devices within green technology fields, such as electric vehicles, battery charging stations, and solar power generation and wind power generation using batteries. In addition, the battery module and battery pack of the present disclosure may be used in eco-friendly electric vehicles and hybrid vehicles to prevent a climate change by suppressing air pollution and greenhouse gas emissions.

In some embodiments of the present disclosure, a battery pack includes: a cell assembly including at least one battery cell; a pack housing accommodating the cell assembly and including a pack frame facing the cell assembly; a gap filling plate mounted on the pack frame and disposed between the pack frame and the cell assembly; a fastening member coupling the gap filling plate to the pack frame; and a ratchet plate disposed between the gap filling plate and the pack frame.

The ratchet plate may include a first ratchet coupled to the pack frame and a second ratchet coupled to the gap filling plate and engaged with the first ratchet, and the ratchet plate may allow the gap filling plate to move in a first direction, opposite to a direction toward the cell assembly, and prevent the gap filling plate from moving in a second direction, opposite to the first direction.

The gap filling plate may include a connection portion connected to the pack frame and a pressing portion connected to the connection portion and facing the at least one battery cell.

The gap filling plate may include a first gap filling plate, at least a portion of the gap filling plate being disposed on one side of the pack frame, and a second gap filling plate, at least a portion of the second gap filling plate being disposed on the other side of the pack frame.

The gap filling plate may include a plurality of ribs protruding from an inner surface of the pressing portion toward the pack frame.

The battery pack may further include an elastic reinforcing member coupled to the gap filling plate and contacting the pack frame and the pressing portion.

The connection portion may include a through-hole, and the elastic reinforcing member may include a pillar portion inserted into the through-hole of the connection portion and an elastic portion connected to the pillar portion and supporting at least one of the pack frame and the pressing portion.

The battery pack may further include an elastic member disposed between the fastening member and the gap filling plate.

The connection portion may include a fastening hole accommodating the fastening member, and the gap filling plate may be structured to move with respect to the pack frame.

The pack housing may include a bottom member supporting a plurality of the cell assemblies, a pack cover covering the cell assemblies, a pack sidewall surrounding at least a portion of a region between the bottom member and the pack cover, and a partition crossing at least a portion of the plurality of the cell assemblies.

The pack frame may include at least one of the pack sidewall and the partition.

In some embodiments of the present disclosure, a battery pack includes: a cell assembly including at least one battery cell; a pack housing accommodating the cell assembly and including a pack frame facing the cell assembly; a gap filling plate mounted on the pack frame and disposed between the pack frame and the cell assembly; a fastening member connecting the gap filling plate to the pack frame; and an elastic member disposed between the fastening member and the gap filling plate, wherein the gap filling plate may include a connection portion connected to the pack frame and a pressing portion connected to the connection portion and facing a portion of the plurality of battery cells, and the connection portion may include a fastening hole and a protrusion surrounding the fastening hole and to contact the elastic member.

A height of the protrusion may increase in a second direction from the pack frame toward the pressing portion.

The gap filling plate may include a plurality of ribs protruding from an inner surface of the pressing portion toward the pack frame.

The battery pack may further include an elastic reinforcing member coupled to the gap filling plate and contacting the pack frame and the pressing portion.

The fastening hole may accommodate the fastening member, and the gap filling plate may be structured to move with respect to the pack frame.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment;

FIG. 2 is an exploded perspective view of a battery pack according to an embodiment;

FIG. 3 is a perspective view of a battery cell, a pack frame, and a gap filling plate according to an embodiment;

FIG. 4 is a cross-sectional view taken along line I-I′ of FIG. 3 according to an embodiment;

FIG. 5 is a perspective view of a battery pack illustrating mounting of a plurality of gap filling plates according to an embodiment;

FIG. 6 is a perspective view of a pack frame, a gap filling plate, and a ratchet plate according to an embodiment;

FIG. 7 is a cross-sectional view taken along line II-II′ of FIG. 6 according to an embodiment;

FIG. 8 is a cross-sectional view taken along line III-III′ of FIG. 6 according to an embodiment;

FIG. 9 is a graph illustrating stepwise pressure changes by a ratchet plate according to an embodiment;

FIG. 10 is a cross-sectional view of a gap filling plate mounted on a pack frame and including a rib region according to an embodiment;

FIG. 11 is a perspective view of an elastic reinforcing member according to an embodiment;

FIG. 12 is a cross-sectional view of a gap filling plate mounted on a pack frame and including an elastic reinforcing member according to an embodiment; and

FIG. 13 is a perspective view of a pack frame and a gap filling plate according to another embodiment.

### DETAILED DESCRIPTION

The present disclosure will be described in detail with reference to the accompanying drawings. However, this is merely illustrative and the present disclosure is not limited to the specific embodiments described by way of example.

Terms and words used in the present specification and claims to be described below should not be construed as limited to ordinary or dictionary terms, and should be construed in accordance with the technical idea of the present disclosure based on the principle that the inventors may properly define their own inventions in terms of terms in order to best explain the invention.

Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

The detailed description of well-known functions and constructions which may obscure the gist of the present disclosure will be omitted. Some of the elements in the accompanying drawings are exaggerated, omitted, or schematically illustrated, and the size of each element does not entirely reflect the actual size.

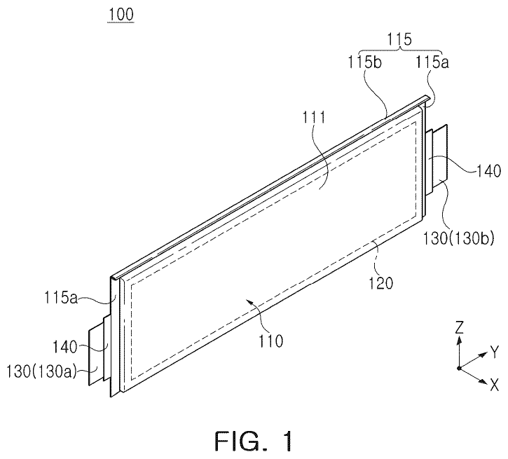

FIG. 1 is a perspective view of a battery cell according to an embodiment.

Referring to FIG. 1, a battery cell 100 may include an electrode assembly 120, a pouch 110 accommodating the electrode assembly 120, and an electrode tab 130 connected to the electrode assembly 120. The battery cell 100 may be a secondary battery. For example, the battery cell 100 may be a lithium ion battery, but is not limited thereto. For example, the battery cell 100 may be a nickel-cadmium battery, a nickel-metal hydride battery, or a nickel-hydrogen battery that may be charged with and discharged of electricity.

The pouch 110 may form at least a portion of the exterior of the battery cell 100. The pouch 110 may include an electrode accommodation portion 111 accommodating the electrode assembly 120 and a sealing portion 115 for sealing at least a portion of the periphery of the electrode accommodation portion 111. The electrode accommodation portion 111 may provide a space for accommodating the electrode assembly 120 and an electrolyte.

The sealing portion 115 may be formed by joining at least a portion of the periphery of the pouch 110. The sealing portion 115 may be formed in a flange shape extending outward from the electrode accommodation portion 111 having a container shape and may be positioned along at least a portion of an outer portion of the electrode accommodation portion 111. In an embodiment, the sealing portion 115 may include a first sealing portion 115a in which the electrode tab 130 is positioned and a second sealing portion 115b in which the electrode tab 130 is not positioned. A portion of the electrode tab 130 may be drawn out or exposed to the outside of the pouch 110.

In an embodiment, the battery cell 100 may include an insulating film 140. At the position at which the electrode tab 130 is drawn out, the electrode tab 130 may be covered by the insulating film 140 to increase the degree of sealing of the first sealing portion 115a and simultaneously ensure electrical insulation. The insulating film 140 is formed of a thinner film material than that of the electrode tab 130 and may be attached to both sides of the electrode tab 130.

In an embodiment, the electrode tabs 130 may be positioned on opposite sides of the battery cell 100 in the length direction of the battery cell 100 so as to face in opposite directions. For example, the electrode tab 130 may include a positive electrode tab 130a having a first polarity (e.g., a positive electrode) facing one side of the battery cell 100 in the length direction and a negative electrode tab 130b having a second polarity (e.g., a negative electrode) facing the other side in the length direction. In the embodiment illustrated in FIG. 1, the sealing portion 115 may include two first sealing portions 115a on which the electrode tabs 130 are positioned and one second sealing portion 115b on which the electrode tabs 130 are not positioned. The electrode tabs 130 may be referred to as electrode leads.

The direction in which the electrode tab 130 is positioned may be selectively designed. In an embodiment, the electrode tabs 130 may include the positive electrode tab 130a and the negative electrode tab 130b positioned in the opposite direction of the positive electrode tab 130a with respect to the electrode assembly 120. In FIG. 1, the electrode tabs 130 are illustrated as being arranged on opposite sides of the battery cell 100 in the length direction of the battery cell 100 to face in the opposite directions, but the structure of the electrode tabs 130 is not limited thereto. For example, two electrode tabs 130 may be arranged substantially parallel in the length direction of the battery cell 100. Meanwhile, the pouch 110 is not limited to the structure illustrated in FIG. 1, in which the sealing portion 115 is formed on three sides by folding a single sheet of outer casing.

In an embodiment of the present disclosure, at least a portion of the sealing portion 115 may be folded at least once. By folding at least a portion of the sealing portion 115, the bonding reliability of the sealing portion 115 may be improved and the area of the sealing portion 115 may be minimized.

The electrode assembly 120 may include a cathode plate, an anode plate, and a separator. The separator may prevent contact between the cathode and anode plates. Those skilled in the art will appreciate that the electrode assembly 120 may be manufactured using various methods. According to embodiments, the positive electrode, the negative electrode, and the separator may be repeatedly arranged to form the electrode assembly 120. In some embodiments, the electrode assembly 120 may be of a winding type, a stacking type, a z-folding type, or a stack-folding type.

The structure of the battery cell 100 illustrated in FIG. 1 is an example. For example, in FIG. 1, the battery cell 100 is described as a pouch-type battery cell, but the structure of the battery cell 100 is not limited thereto. For example, the battery cell 100 may be a cylindrical battery cell or a prismatic battery cell.

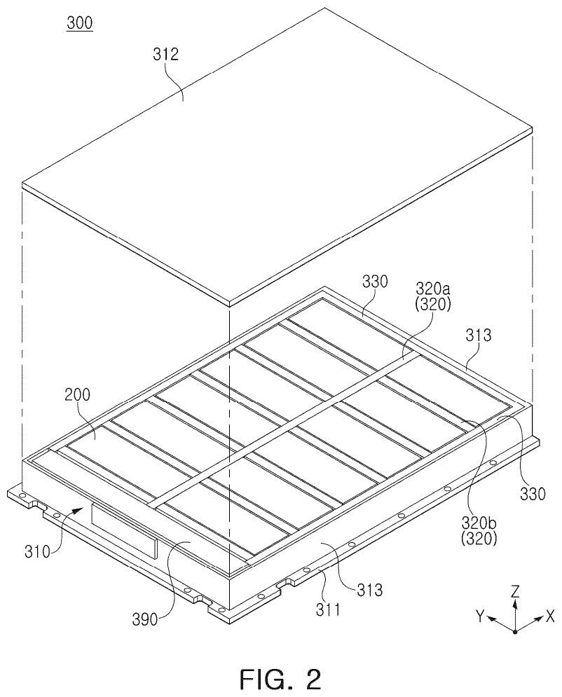

FIG. 2 is an exploded perspective view of a battery pack according to an embodiment.

Referring to FIG. 2, a battery pack 300 may include a plurality of cell assemblies 200, including at least one battery cell (e.g., the battery cell 100 of FIG. 1), and a pack housing 310 accommodating the plurality of cell assemblies 200.

The cell assembly 200 may include at least one battery cell (e.g., the battery cell 100 of FIG. 1). In other words, the battery pack 300 may include the cell assembly 200 including at least one battery cell (e.g., the battery cell 100 of FIG. 1) and a pack housing 310 accommodating the cell assembly 200 including at least one battery cell 100 and including a pack frame 210 facing the cell assembly 200.

In an embodiment, the battery pack 300 may be a cell-to-pack type battery pack 300. In another embodiment, the cell assembly 200 may be replaced with a battery module.

The pack housing 310 may accommodate a component (e.g., the cell assembly 200) of the battery pack 300. The pack housing 310 may include a bottom member 311 supporting a plurality of cell assemblies 200, a pack cover 312 covering the cell assembly 200, and a pack sidewall 313 surrounding at least a portion of a region between the bottom member 311 and the pack cover 312. The bottom member 311 may support the cell assemblies 200.

The pack housing 310 may include a partition 320 intersecting at least a portion of the plurality of cell assemblies 200. For example, the accommodation space of the pack housing 310 may be divided into a plurality of spaces by the partition 320. The partition 320 may be installed across the accommodation space to reinforce the rigidity of the pack housing 310. In an embodiment, the partition 320 may include a first partition 320a extending in a direction in which the plurality of battery cells 100 are arranged and a plurality of second partitions 320b substantially perpendicular to the first partition 320a.

In an embodiment, the battery pack 300 may include a duct member 330. The duct member 330 may include an exhaust space to provide a path for gases and/or flames discharged from the cell assembly 200. The duct member 330 may be disposed within the pack housing 310. The duct member 330 may surround at least a portion of the cell assembly 200. For example, gases and/or flames generated from the battery cell (e.g., the battery cell 100 of FIG. 1) of the cell assembly 200 may pass through the exhaust space of the duct member 330 and be transferred to the outside of the battery pack 300. In the present disclosure, the duct member 330 may be referred to as an exhaust duct or exhaust member.

The battery pack 300 may include a battery controller 390 for controlling the cell assembly 200. The battery controller 390 may be disposed within the pack housing 310. The battery controller 390 may include a battery management system (BMS). The configuration of the battery controller 390 is well known in various forms, and thus, a detailed description will be omitted. In an embodiment, the battery controller 390 may be referred to as a processor.

The structure of the battery pack 300 in FIG. 2 is an example. For example, the number of cell assemblies 200 included in the battery pack 300 and the structure of the pack housing 310 and/or the duct member 330 may be selectively designed.

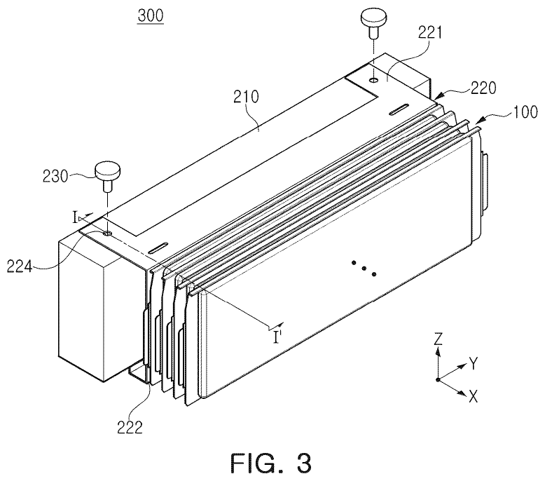

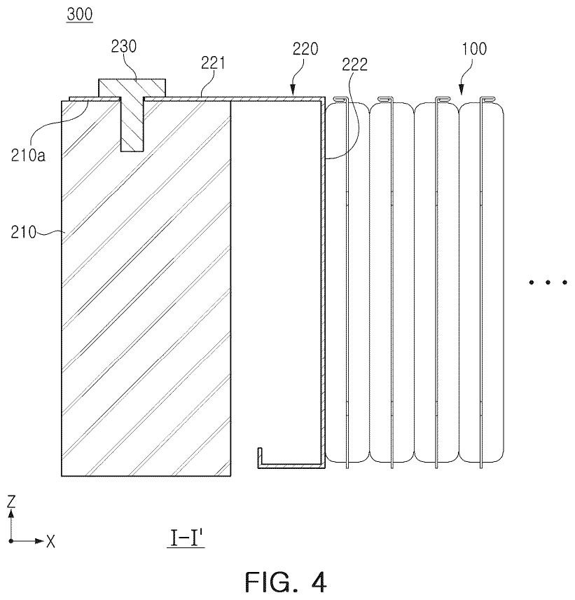

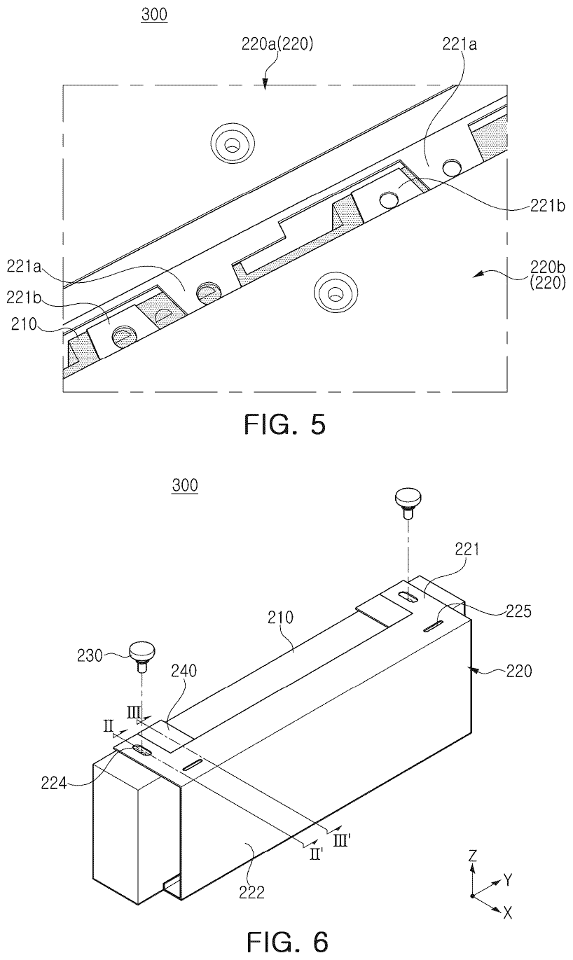

FIG. 3 is a perspective view of a battery cell, a pack frame, and a gap filling plate according to an embodiment. FIG. 4 is a cross-sectional view taken along line I-I′ of FIG. 3 according to an embodiment. FIG. 5 is a perspective view of a battery pack illustrating mounting of a plurality of gap filling plates according to an embodiment.

Referring to FIGS. 3, 4, and/or 5, the battery pack 300 may include a battery cell 100, a pack frame 210, a gap filling plate 220, and a fastening member 230. The descriptions of the battery cell of FIG. 1 and the battery pack 300 and pack housing 310 of FIG. 2 may be applied to the battery cell 100, the pack frame 210, the gap filling plate 220, and the fastening member 230 of FIGS. 3, 4, and/or 5.

The pack frame 210 may face the cell assembly 200 including at least one battery cell (e.g., a battery cell 100 of FIG. 1). Specifically, the pack frame 210 may extend in a direction, perpendicular to the direction in which the plurality of battery cells 100 are arranged, to face the cell assembly. The pack frame 210 may be defined as a portion of the pack housing 310. For example, the pack frame 210 may include at least one of a pack sidewall (e.g., the pack sidewall 313 of FIG. 2) and a partition (e.g., the partition 320b of FIG. 2).

To assemble the battery cell 100 to the pack frame 210, a gap (or tolerance) between the battery cell 100 and the pack frame 210 may be required. The battery cell 100 may be spaced apart from the pack sidewall 313 or the partition 320 of the pack frame 210. However, if the battery cell 100 and the pack frame 210 are spaced apart from each other, the lifespan of the battery cell 100 may be reduced due to the absence of pressure transferred to the battery cell 100.

The gap filling plate 220 may be mounted on the pack frame 210. The pack frame 210 may correspond to a portion of the pack housing 310 in which the gap filling plate 220 is installed.

The gap filling plate 220 may include a connection portion 221 connected to the pack frame 210. The fastening member 230 may connect the gap filling plate 220 to the pack frame 210. For example, the fastening member 230 may be inserted into a fastening hole 224 of the connection portion 221 and a fastening hole (not shown) of the pack frame 210, thereby coupling the gap filling plate 220 to the pack frame 210. In an embodiment, the fastening member 230 may be a bolt.

The gap filling plate 220 may fill the space between the pack frame 210 and the battery cell (e.g., the battery cell 100 of FIG. 1). For example, the gap filling plate 220 may be disposed between the pack frame 210 and the cell assembly 200. The gap filling plate 220 may provide surface pressure to the battery cell 100. Due to the gap filling plate 220, the battery cell 100 may be prevented from deforming (e.g., swelling).

The gap filling plate 220 may include a pressing portion 222 connected to the connection portion 221 and facing at least one battery cell 100. The pressing portion 222 may contact the battery cell 100. The pressing portion 222 may apply pressure to the battery cell 100. Due to the pressing portion 222, the battery cell 100 may be provided with surface pressure. As the battery cell 100 is provided with surface pressure, the lifespan of the battery cell 100 may be improved.

The battery pack 300 may include a plurality of gap filling plates 220. For example, the gap filling plate 220 may include a first gap filling plate 220a at least partially positioned on one side of the pack frame 210 and a second gap filling plate 220b at least partially positioned on the other side of the pack frame 210.

The plurality of gap filling plates 220 may be arranged in an alternating manner with respect to one another. For example, the first gap filling plate 220a may include a plurality of first connection portions 221a coupled to an upper surface 210a of the pack frame 210, and the second gap filling plate 220b may include a plurality of second connection portions 221b coupled to the upper surface 210a of the pack frame 210. At least some of the plurality of first connection portions 221a may be disposed between the plurality of second connection portions 221b. The description of the connection portion 221 may be applied to the first connection portion 221a and the second connection portion 221b.

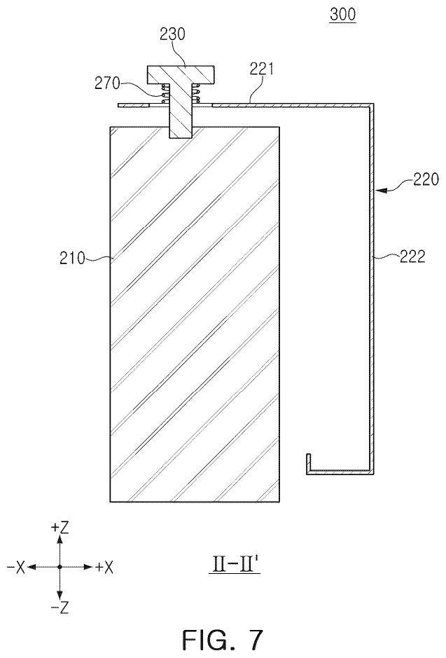

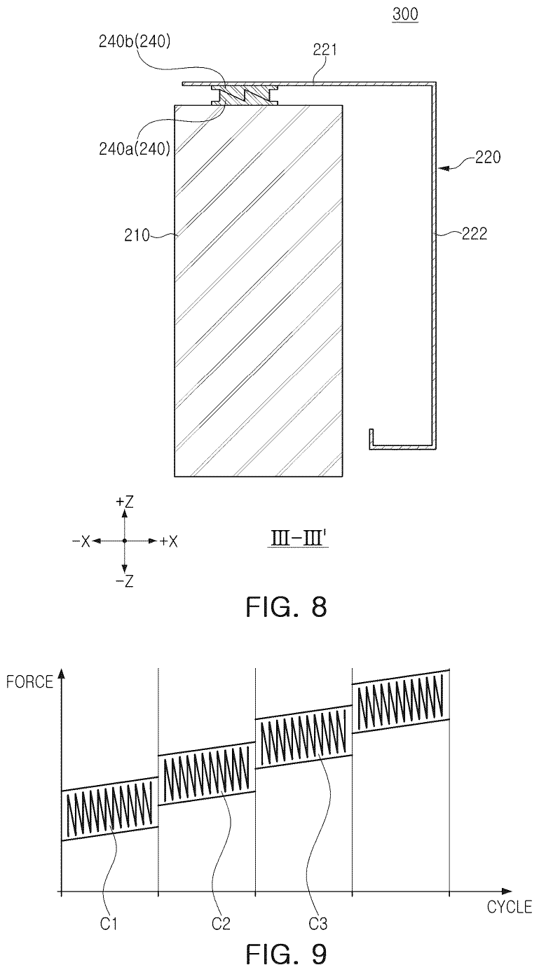

FIG. 6 is a perspective view of a pack frame, a gap filling plate, and a ratchet plate according to an embodiment. FIG. 7 is a cross-sectional view taken along line II-II′ of FIG. 6 according to an embodiment. FIG. 8 is a cross-sectional view taken along line III-III′ of FIG. 6 according to an embodiment. FIG. 9 is a graph illustrating stepwise pressure changes by a ratchet plate according to an embodiment.

Referring to FIGS. 6, 7, 8, and/or 9, the battery pack 300 may include a pack frame 210, a gap filling plate 220, and a fastening member 230. In addition, although omitted in FIGS. 6, 7, and 8, the battery pack 300 may include the battery cell 100. At least a portion of the descriptions of the battery cell 100, the battery pack 300, the pack frame 210, the gap filling plate 220, and the fastening member 230 of FIGS. 3, 4, and/or 5 may be applied to the battery cell 100, the battery pack 300, the pack frame 210, the gap filling plate 220, and the fastening member 230 of FIGS. 6, 7, 8, and/or 9.

The battery pack 300 may include a ratchet plate 240. The ratchet plate 240 may control a direction of movement of the gap filling plate 220. For example, the ratchet plate 240 may allow the gap filling plate 220 to move in a first direction (e.g., the −X direction) opposite to the direction of the gap filling plate 220 toward the cell assembly 200 and prevent the gap filling plate 220 from moving in a second direction (the +X direction) opposite to the first direction (the −X direction). The shape of the ratchet plate 240 is an example. For example, the ratchet plate 240 is not limited as long as it has a shape for controlling the movement direction of the gap filling plate 220. The ratchet plate 240 may be formed to have a plurality of cycle regions C1, C2, and C3.

The ratchet plate 240 may be disposed between the gap filling plate 220 and the pack frame 210. The ratchet plate 240 may include a first ratchet 240a coupled to the pack frame 210 and a second ratchet 240b coupled to the gap filling plate 220 and engaged with the first ratchet 240a.

Due to the ratchet plate 240, the magnitude of pressure that the gap filling plate 220 transmits to the battery cell 100 may be changed. For example, when the battery cell 100 swells, the ratchet plate 240 may enable the gap filling plate 220 to move in the first direction (the-X direction). Due to the movement of the gap filling plate 220, the pressure that the pressing portion 222 of the gap filling plate 220 transmits to the battery cell 100 may be reduced. Due to the ratchet plate 240, the pressure transmitted to the battery cell 100 by the gap filling plate 220 may be changed in stages. As the pressure transferred to the battery cell 100 is changed, the battery cell 100 may receive a specified range of force. As the battery cell 100 receives the specified force, the lifespan of the battery cell 100 may be improved.

In an embodiment, the battery cell 100 may expand as the usage number (e.g., cycles) of the battery cell 100 increases. Due to the expansion of the battery cell 100, the pressure (or force) transferred to the battery cell 100 by the gap filling plate 220 may increase. For example, as the number of cycles of the battery cell 100 increases, the magnitude of force transferred to the battery cell 100 in the first cycle region C1 may increase. The first cycle region C1 may be a period during which the battery cell 100 repeats charging and discharging a specified number of times. For example, the first cycle region C1 may be force applied to the battery cell 100 between a charging curve and a discharging curve. The first cycle region C1 may be a state in which the battery cell 100 expands to a specified size.

When force transferred to the gap filling plate 220 due to the expansion of the battery cell 100 is the specified magnitude or greater, the ratchet plate 240 may move in the first direction (the −X direction). For example, when the force transferred to the gap filling plate 220 is the specified magnitude or greater, the battery pack 300 may change from the first cycle region C1 to the second cycle region C2 due to the movement of the ratchet plate 240. As the battery pack 300 (e.g., the gap filling plate 220) changes from the first cycle region C1 to the second cycle region C2, the pressure applied to the battery cell 100 may be reduced. The second cycle region C2 may be a period during which the battery cell 100 has repeated charging and discharging more times than the first cycle region C1. The second cycle region C2 may be a state in which the battery cell 100 has expanded to a greater extent than the first cycle region C1. Depending on the shape of the ratchet plate 240, the magnitude of pressure transferred to the battery cell 100 may vary. For example, the size and/or range of the cycle regions C1, C2, and C3 may be selectively changed.

The battery pack 300 may include an elastic member 270 disposed between the fastening member 230 and the gap filling plate 220. The movement of the ratchet plate 240 may be adjusted by the elastic member 270. For example, when a magnitude of force transferred to the gap filling plate 220 due to the expansion of the battery cell 100 is the specified magnitude or greater, the ratchet plate 240 may be moved in the first direction (the −X direction), and the specified magnitude may be adjusted by the force provided to the gap filling plate 220 by the elastic member 270 in a third direction (a −Z direction). The elastic member 270 may be a spring.

The battery pack 300 may be formed in a shape allowing movement by the ratchet plate 240. For example, the connection portion 221 of the gap filling plate 220 may include a fastening hole 224 extending in the second direction (the +X direction). The fastening hole 224 may accommodate the fastening member 230. The fastening hole 224 may be referred to as an elongated slot.

The gap filling plate 220 may move with respect to the pack frame 210 in the first direction (the −X direction). Since the fastening hole 224 extends in the second direction (the +X direction), the gap filling plate 220 may move in the first direction (the −X direction) with respect to the pack frame 210 or the fastening member 230. Due to the movement of the gap filling plate 220, the pressure transferred by the pressing portion 222 of the gap filling plate 220 to the battery cell 100 may be reduced.

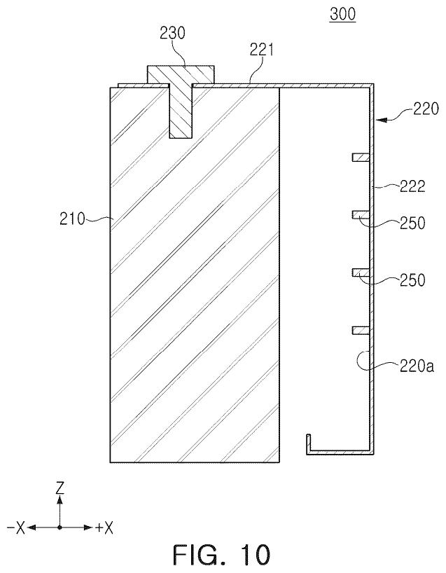

FIG. 10 is a cross-sectional view of a gap filling plate mounted on a pack frame and including a rib region according to an embodiment.

Referring to FIG. 10, the battery pack 300 may include the pack frame 210, the gap filling plate 220, and the fastening member 230. Furthermore, although omitted in FIG. 10, the battery pack 300 may include the battery cell 100. At least a portion of the descriptions of the battery pack 300, the pack frame 210, the gap filling plate 220, and the fastening member 230 of FIGS. 6 through 8 may be applied to the battery pack 300, the pack frame 210, the gap filling plate 220, and the fastening member 230 of FIG. 10. For example, the battery pack 300 of FIG. 10 may include the elastic member 270 of FIG. 7 and/or the ratchet plate 240 of FIG. 8.

The gap filling plate 220 may have a shape to enhance durability. For example, the gap filling plate 220 may include a plurality of ribs 250 protruding from an inner surface 222a of the pressing portion 222 toward the pack frame 210. The ribs 250 may increase the durability of the gap filling plate 220 and reduce damage to the pressing portion 222. The shape of the gap filling plate 220 illustrated in FIG. 10 is an example. For example, the number and/or shape of the ribs 250 may be selectively designed.

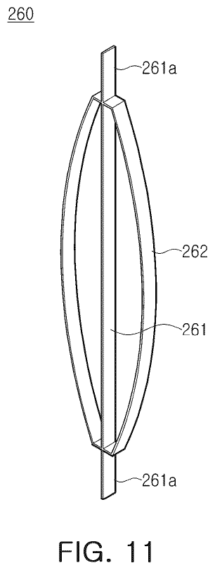

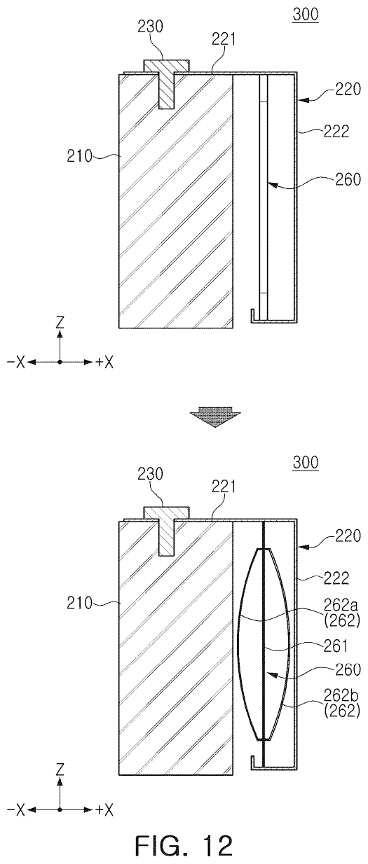

FIG. 11 is a perspective view of an elastic reinforcing member according to an embodiment. FIG. 12 is a cross-sectional view of a gap filling plate mounted on a pack frame and including an elastic reinforcing member according to an embodiment.

Referring to FIGS. 11 and/or 12, the battery pack 300 may include the pack frame 210, the gap filling plate 220, the fastening member 230, and an elastic reinforcing member 260. Although omitted in FIG. 12, the battery pack 300 may include the battery cell 100. At least a portion of the descriptions of the battery pack 300, the pack frame 210, the gap filling plate 220, and the fastening member 230 of FIGS. 6 to 8 or FIG. 10 may be applied to the battery pack 300, the pack frame 210, the gap filling plate 220, and the fastening member 230 of FIG. 12. For example, the battery pack 300 of FIG. 12 may include the elastic member 270 of FIG. 7 and/or the ratchet plate 240 of FIG. 8.

The elastic reinforcing member 260 may include a leaf spring. The elastic reinforcing member 260 may provide pressure to the pack frame 210 and the pressing portion 222. For example, the elastic reinforcing member 260 may be coupled to the gap filling plate 220 and may contact the pack frame 210 and the pressing portion 222. In an embodiment, the elastic reinforcing member 260 may include a pillar portion 261 inserted into a through-hole (e.g., a through-hole 225 of FIG. 6) of the connection portion 221 and an elastic portion 262 connected to the pillar portion 261 and supporting at least one of the pack frame 210 and the pressing portion 222. Both end portions 261a of the pillar portion 261 may be coupled or connected to the gap filling plate 220. The elastic portion 262 may include a first elastic portion 262a facing the pack frame 210 and a second elastic portion 262b connected to the first elastic portion 262a and facing an inner surface 222a of the pressing portion 222.

The elastic reinforcing member 260 may be formed of a leaf spring. The elastic reinforcing member 260 may be inserted into a space between the pack frame 210 and the gap filling plate 220 through the through-hole 225 of the gap filling plate 220. For example, the elastic reinforcing member 260 may be inserted into the through-hole 225 with the first elastic portion 262a and the second elastic portion 262b stretched to be adjacent to the pillar portion 261. After the elastic reinforcing member 260 is inserted into the through-hole 225, the elastic reinforcing member 260 may be rotated so that the first elastic portion 262a and the second elastic portion 262b face the pack frame 210 and the pressing portion 222, respectively. The elastic reinforcing member 260 may contact the pack frame 210 and the pressing portion 222 to absorb at least a portion of the pressure resulting from the expansion of the battery cell 100.

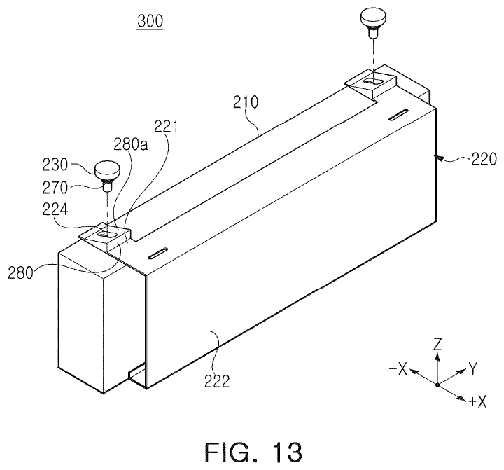

FIG. 13 is a perspective view of a pack frame and a gap filling plate according to another embodiment.

Referring to FIG. 13, the battery pack 300 may include the pack frame 210, the gap filling plate 220, the fastening member 230, and the elastic member 270. In addition, although omitted in FIG. 13, the battery pack 300 may include the battery cell 100.

At least a portion of the descriptions of the battery pack 300, the pack frame 210, the gap filling plate 220, the fastening member 230, and the elastic member 270 of FIGS. 3, 4, 5, 10, and/or 12 may be applied to the battery pack 300, the pack frame 210, the gap filling plate 220, the fastening member 230, and the elastic member 270 of FIG. 13. For example, the gap filling plate 220 of FIG. 13 may include the connection portion 221, the pressing portion 222, and the fastening hole 224 of FIG. 3.

The connection portion 221 of the gap filling plate 220 may include the fastening hole 224. The fastening hole 224 may be formed to extend in the second direction (the +X direction). The fastening hole 224 may accommodate the fastening member 230. The fastening hole 224 may be referred to as an elongated slot. The gap filling plate 220 may be coupled to the pack frame 210 via the fastening member 230 inserted into the fastening hole 224. Since the fastening hole 224 is formed to extend in the second direction (the +X direction), the gap filling plate 220 may move with respect to the pack frame 210 in the first direction (the −X direction).

The connection portion 221 of the gap filling plate 220 may include a protrusion 280 surrounding the fastening hole 224. The protrusion 280 may receive force from the fastening member 230. For example, in an embodiment, the battery pack 300 may include the elastic member 270 disposed between the gap filling plate 220 and the fastening member 230. The protrusion 280 may be a portion of the connection portion 221 facing the elastic member 270 and/or the fastening member 230. The protrusion 280 may contact the elastic member 270. The protrusion 280 may receive force from the elastic member 270.

The protrusion 280 may have a shape to vary resistance due to expansion of the battery cell (e.g., the battery cell 100 of FIG. 1). For example, the height of the protrusion 280 may be variable. By varying the height of the protrusion 280 in part, the magnitude of force transferred by the elastic member 270 to the gap filling plate 220 may be varied. As the magnitude of the force transferred to the gap filling plate 220 is changed, the magnitude of pressure transferred to the battery cell 100 may be changed. In an embodiment, the height (e.g., length in the Z-axis direction) of the protrusion 280 may increase in the second direction (+X direction) from the pack frame 210 toward the pressing portion 222. For example, the protrusion 280 may have different thicknesses depending on parts. The protrusion 280 may include an inclined surface 280a inclined with respect to the pack frame 210. The shape of the protrusion 280 may be selectively designed. In an embodiment, the protrusion 280 may be formed in a substantially stepped shape. In another embodiment, the protrusion 280 may be formed in a substantially parabolic shape.

While the present disclosure has been described with respect to the battery pack 300, it is not limited thereto. For example, the gap filling plate 220 may be disposed between the module housing of the battery module and the battery cell 100.

According to an embodiment of the present disclosure, pressure may be provided to the battery cell.

According to an embodiment of the present disclosure, the lifespan of the battery cell may be improved.

The above-described contents are merely examples adopting the principles of the present disclosure, and other components may be further included without departing from the scope of the present disclosure.

Although the embodiments of the present disclosure have been described above, the scope of the present disclosure is not limited thereto and it will be apparent to those skilled in the art that various modifications and variations may be made within the scope not departing from the technical idea of the present disclosure described in the claims. For example, the present disclosure may be implemented by deleting some of the components in the above-described embodiments, and the respective embodiments may be implemented in combination with each other.

What is claimed is:

1. A battery pack comprising:
a cell assembly including at least one battery cell;
a pack housing accommodating the cell assembly and including a pack frame facing the cell assembly;
a gap filling plate mounted on the pack frame and disposed between the pack frame and the cell assembly;
a fastening member coupling the gap filling plate to the pack frame; and
a ratchet plate disposed between the gap filling plate and the pack frame.

2. The battery pack of claim 1, wherein
the ratchet plate includes a first ratchet coupled to the pack frame and a second ratchet coupled to the gap filling plate and engaged with the first ratchet, and
the ratchet plate allows the gap filling plate to move in a first direction, opposite to a direction toward the cell assembly, and prevents the gap filling plate from moving in a second direction, opposite to the first direction.

3. The battery pack of claim 1, wherein the gap filling plate includes a connection portion connected to the pack frame and a pressing portion connected to the connection portion and facing the at least one battery cell.

4. The battery pack of claim 1, wherein the gap filling plate includes a first gap filling plate, at least a portion of the first gap filling plate being disposed on one side of the pack frame, and a second gap filling plate, at least a portion of the second gap filling plate being disposed on the other side of the pack frame.

5. The battery pack of claim 3, wherein the gap filling plate includes a plurality of ribs protruding from an inner surface of the pressing portion toward the pack frame.

6. The battery pack of claim 3, further comprising an elastic reinforcing member coupled to the gap filling plate and contacting the pack frame and the pressing portion.

7. The battery pack of claim 6, wherein the connection portion includes a through-hole, and the elastic reinforcing member includes a pillar portion inserted into the through-hole of the connection portion and an elastic portion connected to the pillar portion and supporting at least one of the pack frame and the pressing portion.

8. The battery pack of claim 1, further comprising an elastic member disposed between the fastening member and the gap filling plate.

9. The battery pack of claim 3, wherein the connection portion includes a fastening hole accommodating the fastening member, and the gap filling plate is structured to move with respect to the pack frame.

10. The battery pack of claim 1, wherein the pack housing includes a bottom member supporting a plurality of the cell assemblies, a pack cover covering the cell assemblies, a pack sidewall surrounding at least a portion of a region between the bottom member and the pack cover, and a partition crossing at least a portion of the plurality of the cell assemblies.

11. The battery pack of claim 10, wherein the pack frame includes at least one of the pack sidewall and the partition.

12. A battery pack comprising:
a cell assembly including at least one battery cell;
a pack housing accommodating the cell assembly and including a pack frame facing the cell assembly;
a gap filling plate mounted on the pack frame and disposed between the pack frame and the cell assembly;
a fastening member connecting the gap filling plate to the pack frame; and
an elastic member disposed between the fastening member and the gap filling plate,
wherein the gap filling plate includes a connection portion connected to the pack frame and a pressing portion connected to the connection portion and facing a portion of the plurality of battery cells, and the connection portion includes a fastening hole and a protrusion surrounding the fastening hole and contacting the elastic member.

13. The battery pack of claim 12, wherein a height of the protrusion increases in a second direction from the pack frame toward the pressing portion.

14. The battery pack of claim 12, wherein the gap filling plate includes a plurality of ribs protruding from an inner surface of the pressing portion toward the pack frame.

15. The battery pack of claim 12, further comprising an elastic reinforcing member coupled to the gap filling plate and contacting the pack frame and the pressing portion.

16. The battery pack of claim 12, wherein the fastening hole accommodates the fastening member, and the gap filling plate is structured to move with respect to the pack frame.
